(19) United States
(12) Patent Application Publication
(10) Pub. No.: US 2011/0005034 A1
(43) Pub. Date: Jan. 13, 2011

(54) HINGE

(75) Inventor: CHUNG-YI LIN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/541,175

(22) Filed: Aug. 14, 2009

(30) Foreign Application Priority Data
Jul. 8, 2009 (CN) 200910304118.2

(51) Int. Cl. E05D 7/06

(52) U.S. Cl. 16/239

(57) ABSTRACT

A hinge includes a first connecting member, a shaft fixed to the first connecting member, a second connecting member, and a fastener fixed to the shaft. The shaft includes a shaft body including a first resisting surface and a second resisting surface. The second connecting member defines a through hole for the shaft body rotatably passing through the second connecting member. A first block and a second block extend towards each other from a wall bounding the through hole. The first block faces the second resisting surface, and the second block faces the first resisting surface. When the second connecting member is rotated to a predetermined degree relative to the first connecting member, the first block resists against the second resisting surface, and the second block resists against the second resisting surface.

### BACKGROUND

1. Technical Field

The disclosure relates to a hinge.

2. Description of Related Art

A collapsible device, such as a notebook computer or a clamshell mobile phone, generally includes a base and a cover hinged to the base. The hinge allows the cover to be rotatable with respect to the base, and to be folded with the base for saving space.

A hinge normally includes a first element and a second element fixed to the base and the cover of the collapsible device, respectively. The first and second elements are rotatable relative to and in friction engagement with each other for maintaining the cover at a determined angle with respect to the base. However, the first and second elements are not durable after frequent usage and due to wear and tear, as a result, the cover cannot stably maintain a determined angle with respect to the base, which is quite inconvenient for users. Moreover, when the cover is rotated with excessive force, the cover may be over-rotated resulting in damage to the hinge.

### BRIEF DESCRIPTION OF THE DRAWINGS

FIG. 1 is an exploded, isometric view of an exemplary embodiment of a hinge, the hinge including a first connecting member and a second connecting member.

FIG. 2 is similar to FIG. 1, but viewed from another perspective.

FIG. 3 is an assembled, isometric view of the hinge of FIG. 1.

FIG. 4 is an enlarged, partial sectional view of FIG. 3, taken along the line IV-IV.

FIG. 5 is similar to FIG. 4, but showing the second connecting member being rotated an angle relative to the first connecting member.

### DETAILED DESCRIPTION

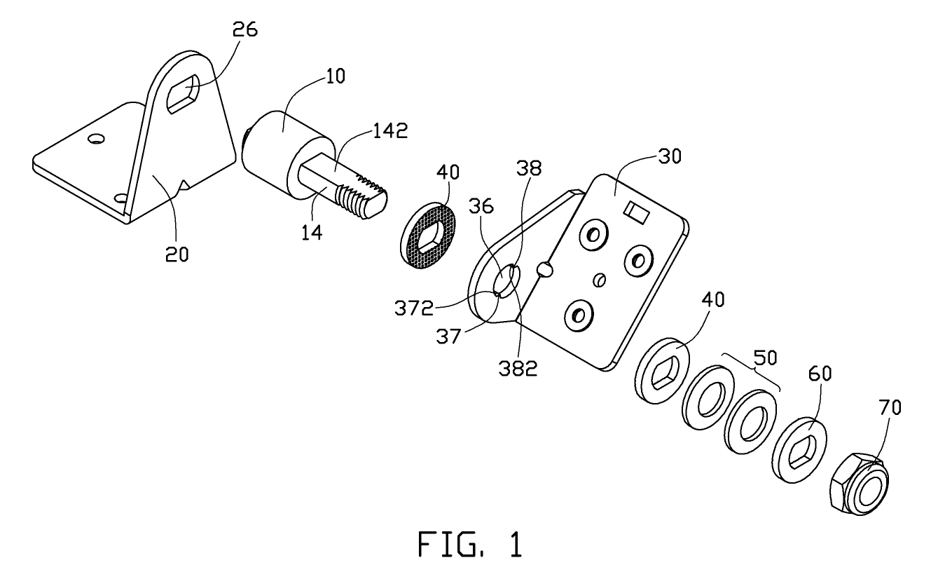

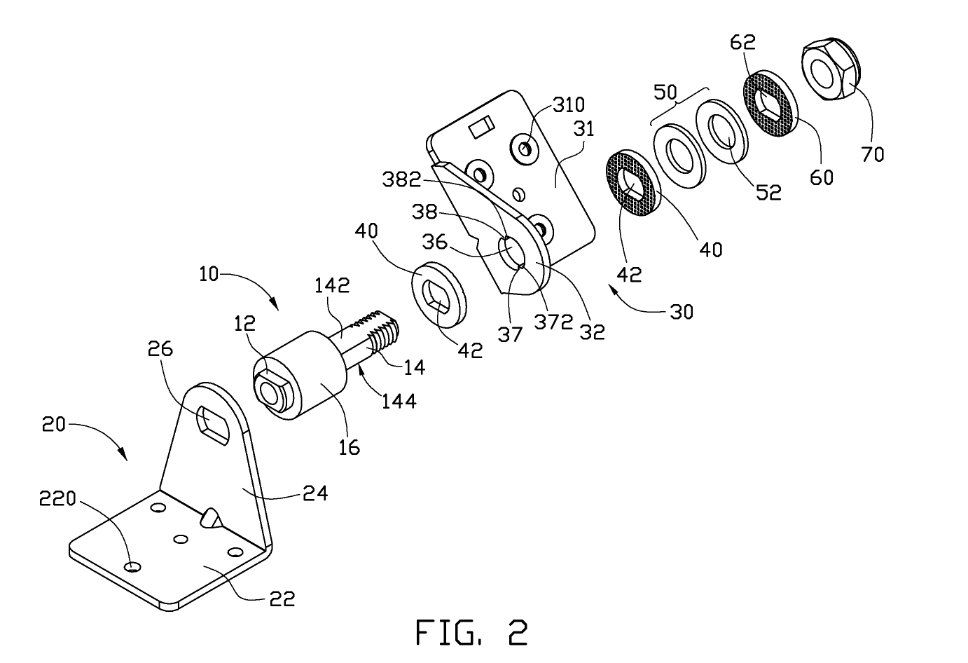

Referring to FIGS. 1 and 2, an exemplary embodiment of a hinge includes a shaft 10, a first connecting member 20, a second connecting member 30, two friction members 40 respectively located against opposite sides of the second connecting member 30, a resilient member 50 including a plurality of elastic rings, a washer member 60, and a fastener 70. In the embodiment, the fastener 70 is a nut.

The shaft 10 includes a resisting portion 16, a fixing portion 12 extending from a first end of the resisting portion 16, and a shaft body 14 extending from a second end opposite to the first end of the resisting portion 16. The resisting portion 16 has a greater diameter than diameters of the fixing portion 12 and the shaft body 14. The fixing portion 12 has a double-D shaped cross-section to enable being fixed to the first connecting member 20. The shaft body 14 includes a first flat resisting surface 142, and a second flat resisting surface 144 opposite to the first resisting surface 142, therefore, the shaft body 34 forms a double-D shaped cross-section. A threaded portion (not labeled) is defined in a circumference of a distal end of the shaft body 14, for engaging with the fastener 70.

The first connecting member 20 is generally L-shaped. The first connecting member 20 includes a connecting portion 22 defining a plurality of fixing holes 220, and a fixing portion 24 perpendicularly extending from a side of the connecting portion 22. The fixing portion 24 defines a fixing hole 26 having a double-D shape corresponding to the fixing portion 12 of the shaft 10, for being unrotatably fixed to the first connecting member 20.

The second connecting member 30 is generally L-shaped. The second connecting member 30 includes a fixing body 31 defining a plurality of fixing holes 310, and a pivoting portion 32 perpendicularly extending from a side of the fixing body 31. The pivoting portion 32 defines a through hole 36 for allowing the shaft body 14 of the shaft 10 to rotatably pass therethrough. A first block 37 and a second block 38 radially extend toward each other from a wall bounding the through hole 36. Each of opposite ends of the first block 37 forms a withstanding surface 372. Similarly, each of opposite ends of the second block 38 forms a withstanding surface 382. In another embodiment, the first block 37 and the second block 38 may be maintained at any angle with respect to each other, which determines an angle the users desire the hinge to provide.

Each friction member 40 defines a double-D shaped shaft hole 42, for being unrotatably mounted to the shaft body 14 of the shaft 10.

The resilient member 50 provides elasticity along an axial direction of the shaft 10, to maintain tight fit between the first connecting member 20, the second connecting member 30, and the friction members 40. Each elastic ring of the resilient member 50 defines a round through hole 52, allowing the shaft body 14 of the shaft 10 to rotatably pass therethrough.

The washer member 60 is generally washer shaped, and defines a fixing hole 62 having double-D shaped, for being unrotatably mounted to the shaft body 14 of the shaft 10.

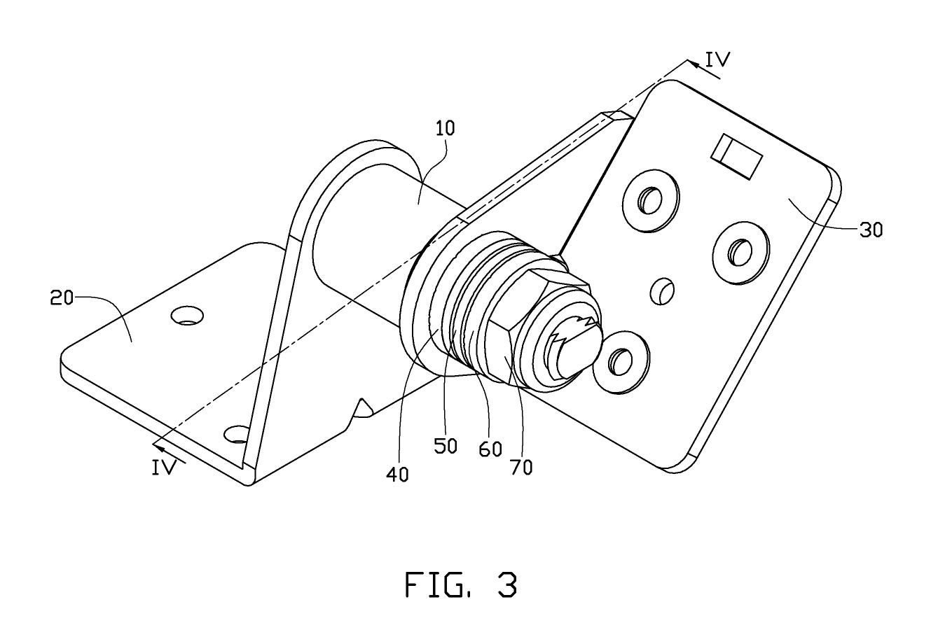

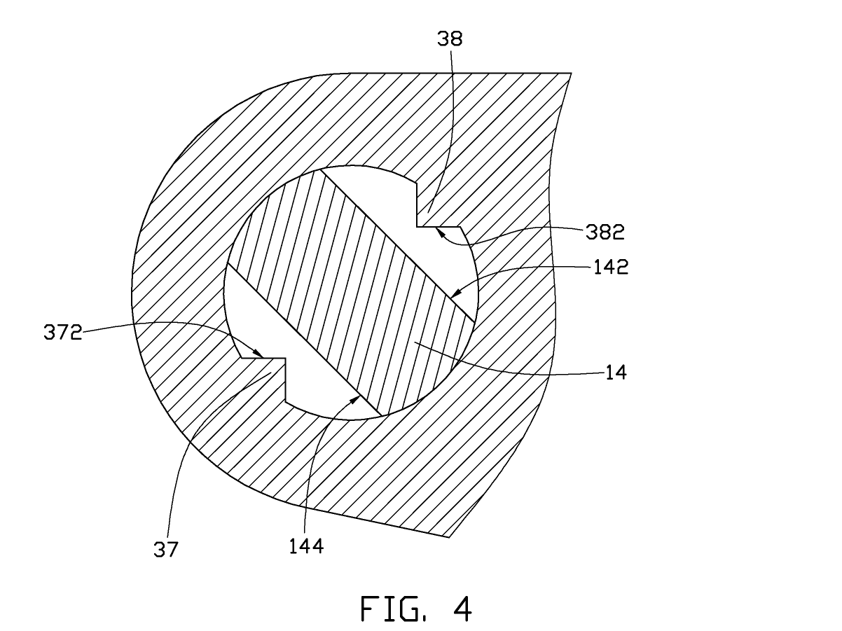

Referring to FIGS. 3 and 4, in assembly, the fixing portion 12 of the shaft 10 is fixedly received in the fixing hole 26 of the first connecting member 20, therefore, the shaft 10 is unrotatably fixed to the first connecting member 20. The shaft body 14 of the shaft 10 is extended through the shaft hole 42 of one of the friction members 40, the through hole 36 of the second connecting member 30, the shaft hole 42 of the other friction member 40, the through holes 52 of the plurality of elastic rings of the resilient member 50, and the fixing hole 62 of the washer 60 one by one in that order, with the distal end of the shaft body 14 engaging in the fastener 70 for preventing the second connecting member 30, the friction members 40, the resilient member 50, and the washer 60 from disengaging from the shaft body 14 of the shaft 10.

In the aforementioned assembly, the second connecting member 30 is rotatably mounted to the shaft body 14 of the shaft 10. The first block 37 faces the second resisting surface 144 of the shaft 10, and the second block 38 faces the first resisting surface 142 of the shaft 10. The friction members 40 resist against opposite sides of the pivoting portion 32 of the second connecting member 30, and one of the friction members 40 further abuts against the resisting portion 16 of the shaft 10.

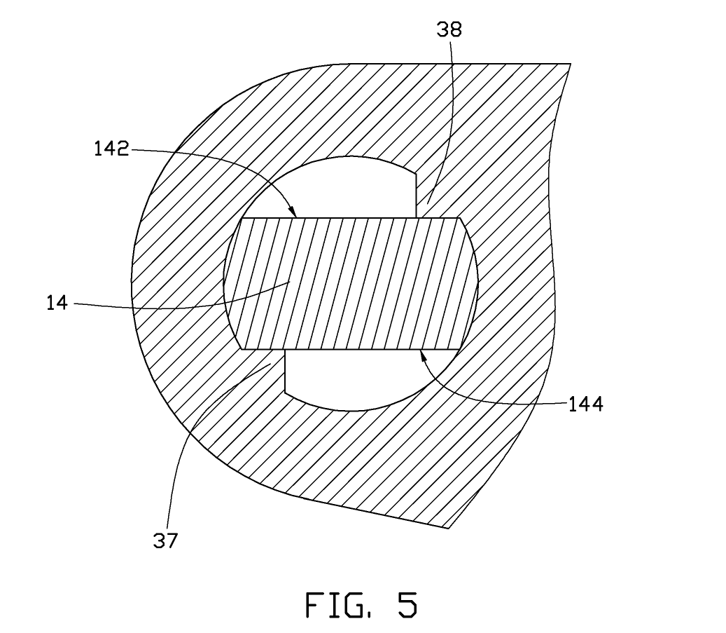

Referring to FIG. 5, in use, the second connecting member 30 is rotated relative to the first connecting member 20, the second connecting member 30 is rotated around the shaft body 14 of the shaft 10. When one of the withstanding surfaces 372 of the first block 37 of the second connecting member 30 resists against the second resisting surface 144 of the shaft body 14, one of the withstanding surfaces 382 of the second block 37 of the second connecting member 30 resists against the first resisting surface 142 of the shaft body 14. Therefore, the second connecting member 30 is stably maintained at a determined angle with respect to the first connecting member 20. Consequently, the second connecting member 30 cannot be rotated further, to prevent the hinge from being over-rotated.

It is believed that the present embodiment and its advantages will be understood from the foregoing description, and it will be apparent that various changes may be made thereto without departing from the spirit and scope of the description or sacrificing all of its material advantages, the example hereinbefore described merely being exemplary embodiment.

What is claimed is:

1. A hinge comprising:
a first connecting member;
a shaft unrotatably fixed to the first connecting member, and comprising a shaft body, the shaft body comprising a first resisting surface and a second resisting surface;
a second connecting member defining a through hole, a first block and a second block radially extending into the through hole from a wall bounding the through hole, wherein the shaft body is rotatably passed through the through hole, the first block faces the second resisting surface, the second block faces the first resisting surface; and
a fastener fixed to a distal end of the shaft body, to prevent the second connecting member from disengaging from the shaft body;
wherein when the second connecting member rotates to a predetermined degree relative to the first connecting member to, the first block resists against the second resisting surface, and the second block resists against the second resisting surface.

2. The hinge of claim 1, wherein each of opposite ends of the first block forms a withstanding surface, the second resisting surface is selectively resists against one of the withstanding surfaces of the first block.

3. The hinge of claim 1, wherein each of opposite ends of the second block forms a withstanding surface, the first resisting surface is selectively resists against one of the withstanding surfaces of the second block.

4. The hinge of claim 1, wherein the first connecting member defines a double-D shaped fixing hole, the shaft comprise a fixing portion having a double-D shaped cross-section to be fixedly received in the fixing hole.

5. The hinge of claim 4, further comprising two friction members unrotatably mounted to the shaft body, wherein the shaft further comprise a washer shaped resisting portion between the fixing portion and the shaft body, opposite sides of one of the friction members resist against the resisting portion and the second connecting member, respectively.

6. The hinge of claim 5, further comprising a resilient member rotatably mounted to the shaft body, wherein opposite sides of the other one of the friction members resist against the second connecting member and the resilient member, respectively.

7. A hinge comprising:
a first connecting member;
a shaft unrotatably fixed to the first connecting member, the shaft comprising a flat first resisting surface, and a flat second resisting surface opposite to the first resisting surface;
a second connecting member rotatably mounted to the shaft, and comprising a first block and a second block opposite to the first block, the first block extending from the second connecting member and facing the second resisting surface, the second block extending from the second connecting member and facing the first resisting surface, wherein when the second connecting member is rotated relative to the first connecting member, the first block is moved towards to resist against the second resisting surface, in the meanwhile, the second block is moved towards to resist against the first resisting surface; and
a fastener fixed to a distal end of the shaft, to prevent the second connecting members from disengaging from the shaft.

8. The hinge of claim 7, wherein the shaft comprises a shaft body, the second connecting member defines a through hole for the shaft body rotatably passing therethrough.

9. The hinge of claim 8, wherein the first block radially extends from an inner side bounding the through hole, each of opposite ends of the first block forms a withstanding surface, the second resisting surface is formed on the shaft body, to selectively resist against one of the withstanding surfaces of the first block.

10. The hinge of claim 8, wherein the second block radially extends from an inner side bounding the through hole, each of opposite ends of the second block forms a withstanding surface, the first resisting surface is formed on the shaft body, to selectively resist against one of the withstanding surfaces of the second block.

11. The hinge of claim 7, wherein the first connecting member defines a double-D shaped fixing hole, the shaft comprise a fixing portion to be fixedly received in the fixing hole.

12. The hinge of claim 11, further comprising two friction members, wherein the shaft further comprises a shaft body opposite to the fixing portion, and a resisting portion between the fixing portion and the shaft body, the friction members are unrotatably mounted to the shaft body, opposite sides of one of the friction members resist against the resisting portion and the second connecting member, respectively.

13. The hinge of claim 12, further comprising a resilient member rotatably mounted to the shaft body, wherein opposite sides of the other one of the friction members resist against the second connecting member and the resilient member, respectively.
